(19) United States
(12) Patent Application Publication
(10) Pub. No.: US 2017/0060311 A1
(43) Pub. Date: Mar. 2, 2017

(54) TOUCH DEVICE WITH REDUCED TEMPERATURE EFFECT THEREON

(71) Applicant: Liyitec Incorporated, Taoyuan City (TW)

(72) Inventor: Shu-Chen Hsu, Taoyuan City (TW)

(21) Appl. No.: 15/065,387

(22) Filed: Mar. 9, 2016

(30) Foreign Application Priority Data
Aug. 28, 2015 (TW) 104214045

(51) Int. Cl. G06F 3/041

(52) U.S. Cl. CPC G06F 3/0412; G06F 2203/04103; G06F 2203/04107

(57) ABSTRACT

A touch device with reduced temperature effect thereon includes a display, a transparent substrate, a heat-shielding layer and a touch sensing layer. The transparent substrate is bonded on the display. The touch sensing layer is formed on the transparent substrate. The heat-shielding layer is formed between the transparent substrate and the touch sensing layer by vacuuming a space occupied by the heat-shielding layer by a vacuum process. When the touch device is operated in a low-temperature environment, due to the vacuumed heat-shielding layer, moisture generated by a difference between temperatures inside and outside the touch device can be reduced and the aging speed of the touch device can be slowed down, thereby effectively enhancing the yield of the touch device.

### BACKGROUND OF THE INVENTION

1. Field of the Invention

The present invention relates to a touch device and, more particularly, to a touch device with reduced temperature effect thereon.

2. Description of the Related Art

The advancement of semiconductor fabrication technology has quickly developed the display device from the display screens back in early days to the touch devices and small-size touch devices applied to current personal mobile devices, allowing the mobile devices to be accompanied with people from all walks of life and used everywhere in the world for betterment of convenience and entertainment in daily life.

Conventional touch devices have been extensively applied to all fields including public equipment and transportation tools. Usually, public equipment has stricter requirements against weather effect than private equipment, especially for outdoor use, because the touch devices sometimes become uncontrollable due to variation in temperature. A countermeasure to the temperature issue is to attach a touch sensing layer on a display and install the touch device on public equipment, such as ATM (Automatic Teller Machine), parking meters for curb parking and the like. When the conventional touch devices are operated at an ambient temperature that is lower than the temperature inside the touch devices, moisture is easily generated between the touch sensing layer and the touch devices because of the temperature difference. When the touch devices are operated in a high-temperature environment, the electronic components of the touch devices are easily damaged by heat coming from the high-temperature environment. Accordingly, the conventional touch devices have shorter life duration and are failure-prone.

### SUMMARY OF THE INVENTION

An objective of the present invention is to provide a touch device with reduced temperature effect thereon, which mitigates the temperature effect on the touch device, reduces generation of moisture, and prolongs the operation duration of the touch device.

To achieve the foregoing objective, the touch device with reduced temperature effect thereon includes a display, a transparent substrate, a heat-shielding layer and a touch sensing layer.

The transparent substrate is bonded on a top surface of the display.

The heat-shielding layer is formed on a top surface of the transparent substrate.

The touch sensing layer is formed on a top surface of the heat-shielding layer.

Insulation adhesive is filled in an insulation space in a vacuum between the transparent substrate and the touch sensing layer to form the heat-shielding layer.

As can be seen from the foregoing structure of the touch device, the heat-shielding layer between the transparent substrate and the touch sensing layer is prepared by a vacuum process. The vacuumed heat-shielding layer can effectively reduce generation of moisture arising from a difference between temperatures inside and outside the touch device and thus increase the operation duration and yield of the touch device.

Other objectives, advantages and novel features of the invention will become more apparent from the following detailed description when taken in conjunction with the accompanying drawings.

### BRIEF DESCRIPTION OF THE DRAWINGS

FIG. 1 is a schematic cross-sectional side view of a first embodiment of a touch device with reduced temperature effect thereon in accordance with the present invention;

FIG. 2 is a schematic cross-sectional side view of the touch device in FIG. 2 when a touch sensing layer is not fin med on the touch device;

FIG. 3 is a schematic cross-sectional side view of the touch device in FIG. 2 when a touch sensing layer is formed on the touch device; and

FIG. 4 is a schematic cross-sectional side view of a second embodiment of a touch device with reduced temperature effect thereon in accordance with the present invention.

### DETAILED DESCRIPTION OF THE INVENTION

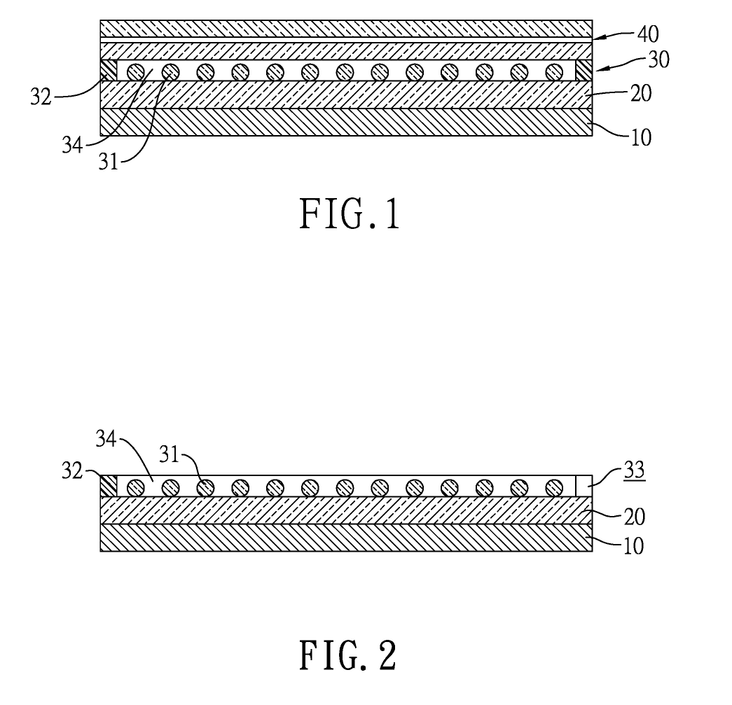

With reference to FIG. 1, a first embodiment of a touch device with reduced temperature effect thereon in accordance with the present invention includes a display 10, a transparent substrate 20, a heat-shielding layer 30, and a touch sensing layer 40. The transparent substrate 20 is bonded on a top surface of the display 10. The heat-shielding layer 30 is formed on a top surface of the transparent substrate 20. The touch sensing layer 40 is formed on a top surface of the heat-shielding layer 30. In the present embodiment, the transparent substrate 20 is formed by a glass substrate or a transparent and resilient material.

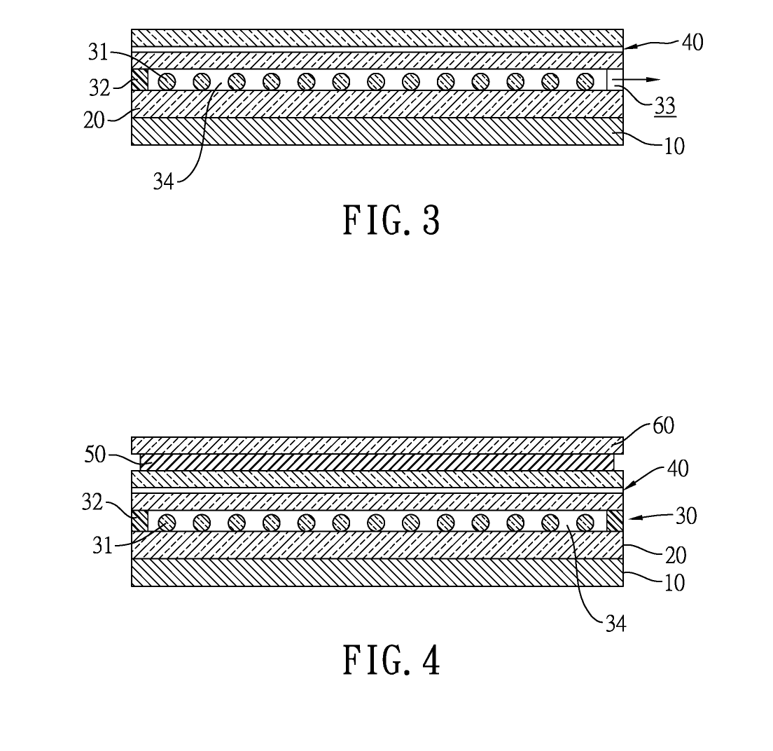

As to how the heat-shielding layer 30 is prepared, with respect to FIGS. 2 and 3, the heat-shielding layer 30 has multiple dot spacers 31. The multiple dot spacers 31 are formed on the top surface of the transparent substrate 20 and are evenly spaced apart from each other by gaps. The multiple dot spacers 31 are fabricated by coating a polymer film on the transparent substrate 20 and forming the multiple dot spacers 31 inside the polymer film through a screen-printing process or a photolithography process, and serve to enhance support capacity of the touch device. A portion of the polymer film not occupied by the multiple dot spacers 31 is etched to form an insulation space 34. Insulating adhesive 32 is pasted on a perimeter of the top surface of the transparent substrate 20. An opening 33 is formed in the insulating adhesive 32 at a portion on the perimeter of the top surface of the transparent substrate 20 to communicate with the insulation space 34 in the heat-shielding layer 30 and is prepared for a subsequent vacuum process. In the present embodiment, the multiple dot spacers 31 are made of a transparent material. The way of preparing the multiple dot spacers 31 in the present embodiment is applicable to large-size touch devices. In case of small-size touch devices, the multiple dot spacers 31 of the heat-shielding layer 30 are not necessarily prepared.

The insulation space 34 in the heat-shielding layer 30 is vacuumed by the vacuum process, such that, the vacuumed insulation space 34 is filled with the insulating adhesive 32 through the opening 33 to form the heat-shielding layer 30 in a vacuum.

With reference to FIG. 4, a second embodiment of a touch device with reduced temperature effect thereon in accordance with the present invention differs from the first embodiment in an additional protection layer 50 fowled on a top surface of the touch sensing layer 40 and a light-transmitting layer 60 bonded on a top surface of the protection layer 50 for increasing a protection capability of the touch device. In the present embodiment, the protection layer 50 is formed by evenly painting a bonding agent mixed with titanium dioxide (TiO₂) nanoparticles or zinc oxide (ZnO) nanoparticles on the touch sensing layer 40. As the titanium dioxide nanoparticles or zinc oxide nanoparticles can absorb ultraviolet light, an aging effect caused by ultraviolet light on the touch device can be effectively reduced. The bonding agent is light-transmitting. The light-transmitting layer 60 may be formed by reinforced glass capable of transmitting light.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A touch device with reduced temperature effect thereon, comprising:
a display;
a transparent substrate bonded on a top surface of the display;
a heat-shielding layer formed on a top surface of the transparent substrate; and
a touch sensing layer formed on a top surface of the heat-shielding layer;
wherein insulation adhesive is filled in an insulation space in a vacuum between the transparent substrate and the touch sensing layer to form the heat-shielding layer.

2. The touch device as claimed in claim 1, wherein the heat-shielding layer has multiple dot spacers formed on the transparent substrate, spaced apart from each other, and made of a transparent material.

3. The touch device as claimed in claim 2, wherein the insulating adhesive is pasted on a perimeter of the top surface of the transparent substrate.

4. The touch device as claimed in claim 1, further comprising a protection layer formed on a top surface of the touch sensing layer.

5. The touch device as claimed in claim 2, further comprising a protection layer formed on a top surface of the touch sensing layer.

6. The touch device as claimed in claim 3, further comprising a protection layer thinned on a top surface of the touch sensing layer.

7. The touch device as claimed in claim 4, further comprising a light-transmitting layer bonded on a top surface of the protection layer and formed by reinforced glass capable of transmitting light.

8. The touch device as claimed in claim 5, further comprising a light-transmitting layer bonded on a top surface of the protection layer and formed by reinforced glass capable of transmitting light.

9. The touch device as claimed in claim 6, further comprising a light-transmitting layer bonded on a top surface of the protection layer and formed by reinforced glass capable of transmitting light.

10. The touch device as claimed in claim 7, wherein the protection layer is formed by evenly painting a bonding agent mixed with titanium dioxide (TiO₂) nanoparticles or zinc oxide (ZnO) nanoparticles on the touch sensing layer.

11. The touch device as claimed in claim 8, wherein the protection layer is formed by evenly painting a bonding agent mixed with titanium dioxide (TiO₂) nanoparticles or zinc oxide (ZnO) nanoparticles on the touch sensing layer.

12. The touch device as claimed in claim 9, wherein the protection layer is formed by evenly painting a bonding agent mixed with titanium dioxide (TiO₂) nanoparticles or zinc oxide (ZnO) nanoparticles on the touch sensing layer.

13. The touch device as claimed in claim 1, wherein the transparent substrate is formed by a glass substrate or a transparent and resilient material.

14. The touch device as claimed in claim 2, wherein the transparent substrate is formed by a glass substrate or a transparent and resilient material.

15. The touch device as claimed in claim 3, wherein the transparent substrate is formed by a glass substrate or a transparent and resilient material.

16. The touch device as claimed in claim 7, wherein the transparent substrate is formed by a glass substrate or a transparent and resilient material.

17. The touch device as claimed in claim 8, wherein the transparent substrate is formed by a glass substrate or a transparent and resilient material.

18. The touch device as claimed in claim 9, wherein the transparent substrate is formed by a glass substrate or a transparent and resilient material.

19. The touch device as claimed in claim 10, wherein the transparent substrate is formed by a glass substrate or a transparent and resilient material.

20. The touch device as claimed in claim 11, wherein the transparent substrate is formed by a glass substrate or a transparent and resilient material.
